(19) United States
(12) Patent Application Publication
(10) Pub. No.: US 2026/0279948 A1
(43) Pub. Date: Sep. 17, 2026

(54) LOW VOLTAGE HEATING CONFIGURATION FOR HIGH VOLTAGE ELECTRIFIED VEHICLE BATTERY

(71) Applicant: FCA US LLC, Auburn Hills, MI (US)

(72) Inventor: James Shindelar, Auburn Hills, MI (US)

(21) Appl. No.: 19/081,027

(22) Filed: Mar. 17, 2025

(51) Int. Cl. H01M 10/615; H01M 10/613; H01M 10/625; H01M 10/635; H01M 10/6556; H01M 10/6571

(52) U.S. Cl. CPC H01M 10/615; H01M 10/613; H01M 10/625; H01M 10/635; H01M 10/6556; H01M 10/6571; H01M 2220/20

(57) ABSTRACT

A thermal management system for an electrified vehicle includes a high voltage battery pack assembly, a low voltage battery, a cooling system and a low voltage heating system. The high voltage battery pack assembly comprises a battery module assembly that houses a plurality of battery cells within a high voltage battery case. The cooling system includes a cold plate that is configured to cool the high voltage battery pack assembly. The low voltage heating system comprises a heating assembly having a resistive heating element. The low voltage heating system is powered by the low voltage battery and attached to the cold plate.

### FIELD

The present application generally relates to electrified vehicles and, more particularly, to a low voltage heating configuration on a high voltage electrified vehicle battery.

### BACKGROUND

An electrified vehicle (hybrid electric, plug-in hybrid electric, range-extended electric, battery electric, etc.) includes at least one battery system and at least one electronic drive module having an electric motor and associated electric drive gearbox assembly. Typically, the electrified vehicle would include a high voltage battery system and a low voltage (e.g., 12 volt) battery system. In such a configuration, the high voltage battery system is utilized to power at least one electric motor configured on the vehicle and to recharge the low voltage battery system via a direct current to direct current (DC-DC) convertor. The high voltage battery system generally includes a battery pack or module assembly that includes a housing that houses a plurality of battery cells. The high voltage battery system generally does not operate efficiently at low temperatures. In this regard, for optimal performance, the electrified vehicle needs to provide a heat source to the battery cells. Traditionally, a high voltage coolant heater is provided that heats the battery cells. These high voltage coolant heaters generally operate together with a heat pump system and leverage other heating cooling and air conditioning (HVAC) components. Such high voltage coolant heaters and heat pump systems are large, heavy and expensive. Accordingly, while such heating and cooling strategies do work well for their intended purpose, there is a desire for improvement in the relevant art.

### SUMMARY

According to one example aspect of the invention, a thermal management system for an electrified vehicle includes a high voltage battery pack assembly, a low voltage battery, a cooling system and a low voltage heating system. The high voltage battery pack assembly comprises a battery module assembly that houses a plurality of battery cells within a high voltage battery case. The cooling system includes a cold plate that is configured to cool the high voltage battery pack assembly. The low voltage heating system comprises a heating assembly having a resistive heating element. The low voltage heating system is powered by the low voltage battery and attached to the cold plate.

In some implementations, the thermal management system further comprises a low voltage heating system controller that commands the low voltage heating system to activate based on an input indicative of a temperature threshold being satisfied.

In some implementations, the heating assembly includes a collection of heating grids.

In some implementations, the heating assembly further comprises an adhesive that couples the low voltage heating system to the cold plate.

In some implementations the adhesive comprises thermal glue.

In additional aspects, the cooling system further comprises a chiller, a coolant fluid circuit and a coolant pump, wherein the coolant pump is configured to move coolant fluid through the coolant fluid circuit.

In additional features, the heating element is a resistive heating element.

In additional arrangements, the cooling system is exclusive to cooling the cold plate without heating the coolant.

In some examples, the heating element is disposed within the high voltage battery case.

According to one example aspect of the invention, a method of operating a thermal management system for an electrified vehicle is provided. The thermal management system comprises a high voltage battery pack assembly comprising a battery module assembly that houses a plurality of battery cells within a high voltage battery case, a low voltage battery, a cooling system including a cold plate that is configured to cool the high voltage battery pack assembly, and a low voltage heating system comprising a heating assembly having a heating element, the low voltage heating system powered by the low voltage battery and attached to the cold plate. The method includes: receiving, at a low voltage heating system controller, at least one input indicative of a temperature measurement; determining, at the low voltage heating system controller, whether the at least one input satisfies a cold temperature threshold; and activating the heating assembly based on the at least one input satisfying the cold temperature threshold.

In other examples of the method, the heating assembly includes a collection of heating grids.

In additional examples of the method, the heating assembly further comprises an adhesive that couples the low voltage heating system to the cold plate.

In other implementations of the method, the adhesive comprises thermal glue.

In additional examples of the method, the cooling system further comprises a chiller, a coolant fluid circuit and a coolant pump, wherein the coolant pump is configured to move coolant fluid through the coolant fluid circuit.

In other implementations of the method, the heating element is a resistive heating element.

In other examples of the method, the cooling system is exclusive to cooling the cold plate without heating the coolant.

In additional examples of the method, the heating element is disposed within the high voltage battery case.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of an electrified vehicle having a battery pack assembly that incorporates a high voltage battery pack thermal management system that includes a low voltage heating assembly according to various principles of the present application;

FIG. 2 is a schematic illustration of the high voltage battery pack system that incorporates the high voltage battery pack thermal management system of FIG. 1 and includes a low voltage heating assembly according to examples of the present disclosure; and

FIG. 3 is a schematic illustration of a high voltage battery system having a high voltage battery pack thermal management system according to one prior art arrangement.

### DESCRIPTION

As discussed above, the high voltage battery system of an electrified vehicle generally includes a battery pack or module assembly that includes a housing that houses a plurality of battery cells. The high voltage battery system generally does not operate efficiently at low temperatures. To address this, the electrified vehicle needs to provide a heat source to the battery cells. Traditionally, a high voltage coolant heater is provided that heats the battery cells. These high voltage coolant heaters generally operate together with a heat pump system and leverage other heating cooling and air conditioning (HVAC) components. Such high voltage coolant heaters and heat pump systems are undesirable as they tend to be large, heavy and expensive.

The present disclosure provides a low cost, low voltage (such as 12-16 volts) resistive heating element that is configured on the internal cooling plate of the high voltage battery system of the electrified vehicle. The low voltage resistive heating element is powered by a low voltage battery system in the vehicle. In examples, the resistive heating element includes a collection of grids and wires. In some implementations, the resistive heating element is bonded (e.g., glued) to the internal cooling plate of the high voltage battery system. The resistive heating element utilizes a pre-existing thermal interface to the battery cells of the battery coolant cold plate, essentially giving it a dual purpose as a warming plate. As a result, the resistive heating element provides a low voltage heater inside the high voltage battery system that adds supplemental heat to the battery cells of the high voltage battery system for relatively how cost and weight.

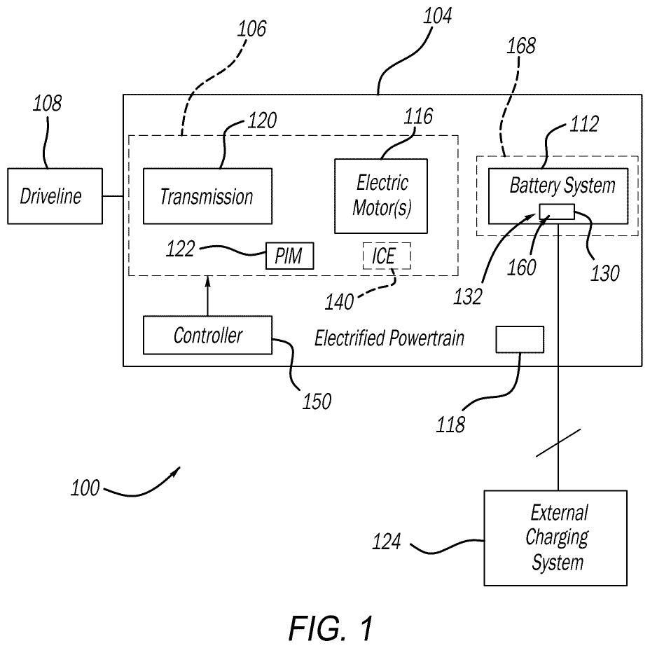

Referring now to FIG. 1, a functional block diagram of an example electrified vehicle 100 (also referred to herein as “vehicle 100”) according to the principles of the present application is illustrated. The electrified vehicle 100 includes an electrified powertrain 104 having an electric drive module (EDM) 106 configured to generate and transfer drive torque to a driveline 108 for vehicle propulsion. The EDM 106 generally includes one or more electric drive units or motors 116 (e.g., electric traction motors), an electric drive gearbox assembly or transmission 120, and power electronics including a power inverter module (PIM) 122.

The electric motor 116 is selectively connectable via the PIM 124 to a high voltage battery system 112 for powering the electric motor 116. A low-voltage battery 118 (e.g., 12 volt) can be disposed in the electrified vehicle 100 that is generally configured to power low voltage components of the electrified vehicle 100. The high voltage battery system 112 is selectively connectable (e.g., by the driver) to an external charging system 124 (also referred to herein as “charger 124”) for charging of the high voltage battery system 112. The high voltage battery system 112 includes at least one battery pack assembly 130. In some examples, the electrified powertrain 104 can be a hybrid powertrain that additionally includes an internal combustion engine 140. A powertrain controller 150 can provide various inputs to the EDM 106 related to selectively switching power inputs between the electric motors 116 and the ICE 140.

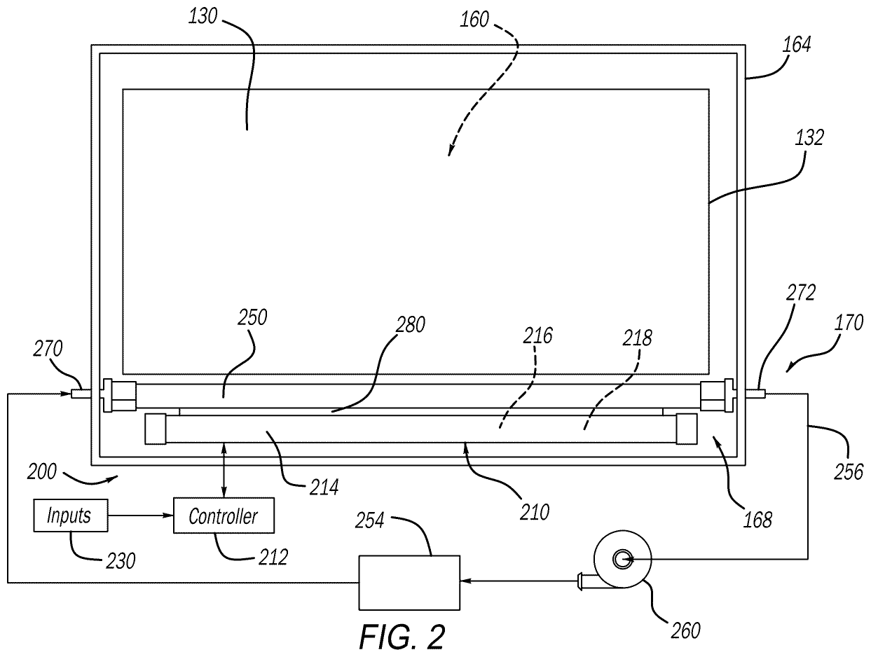

With particular reference now to FIGS. 1 and 2, the battery pack assembly 130 constructed in accordance to various examples of the present disclosure will be described. The battery pack assembly 130 includes a battery module assembly 132 that generally houses a plurality of respective cells collectively identified at 160 in a high voltage battery case 164. The battery pack assembly 130 further includes a high voltage battery pack thermal management system 168.

As explained above, the high voltage battery pack thermal management system 168 incorporates a cooling system 170 and a low voltage heating system 200. The low voltage heating system 200 generally includes a low voltage heating assembly 210 and a low voltage heating system controller 212. The low voltage heating assembly 210 includes a heating element 214. In examples, the heating element 214 can include a resistive heating element having a collection of grids 216 and wires 218. As will be described herein, the low voltage heating system controller 212 can command the low voltage heating assembly 210 to activate based on receiving inputs 230 indicative of a cold temperature threshold being reached. In examples, the inputs 230 can be a temperature signal indicative of one or more measured or otherwise determined operating temperatures (e.g., ambient temperature, system temperature, component temperate or combinations thereof). The low voltage heating assembly 210 can be powered by the low-voltage battery 118 (FIG. 1).

The high voltage battery pack thermal management system 168 includes the cooling system 170 that generally includes a coolant cold plate 250, a chiller 254, a coolant fluid circuit 256 and a coolant pump 260. The coolant pump 260 moves coolant fluid through the coolant fluid circuit 256. In doing so, coolant is caused to be pumped by the coolant pump 260 in and out of the chiller 254. Furthermore, coolant is caused to flow into the coolant cold plate 250 at a coolant inlet port 270 and out of the coolant cold plate 250 at a coolant outlet port 272.

In the example provided, the heating assembly 200 further includes a coupling member 280 that couples the heating element 214 to the cold plate 250. According to the present disclosure, the coupling member 280 comprises thermal glue. In advantages, the thermal glue facilitates attachment of the heating element 214 to the cold plate 250 and further facilitates heat transfer from the heating element 210 to the cold plate 250.

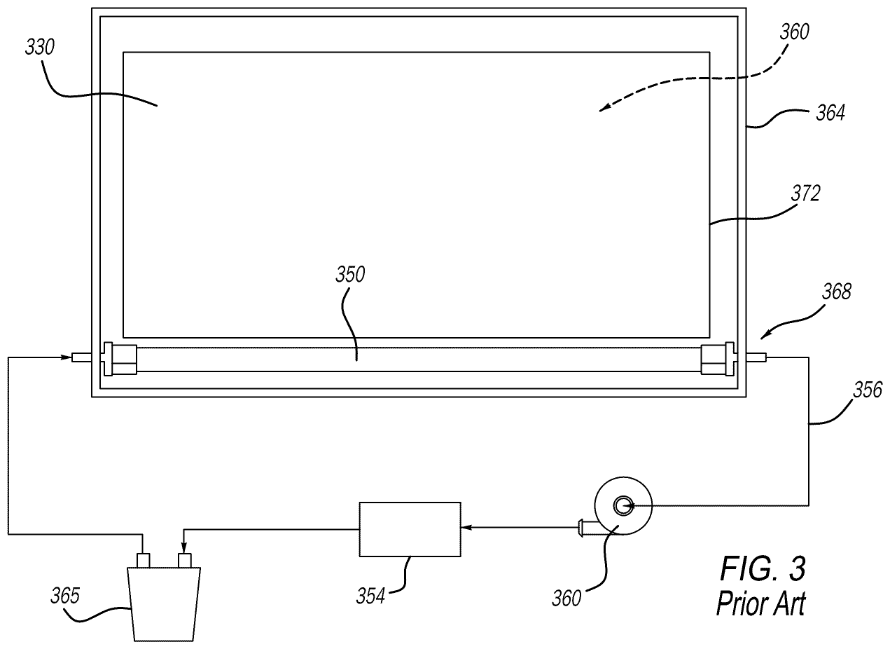

With particular reference now to FIG. 3, a battery pack assembly 330 constructed in accordance to one prior art example will be described. The battery pack assembly 330 includes a battery module assembly 332 that generally houses a plurality of respective cells collectively identified at 360 in a high voltage battery case 364. The battery pack assembly 330 further includes a high voltage battery pack heating and thermal management system 368.

The high voltage battery pack thermal management system 368 according to the prior art example shown generally includes a coolant cold plate 350, a chiller 354, a coolant fluid circuit 356, a coolant pump 260, and a high voltage coolant heater 365. The coolant pump 360 moves coolant fluid through the coolant fluid circuit 356. In doing so, coolant is caused to be pumped by the coolant pump 360 in and out of the chiller 354. Fluid is further caused to flow through the high voltage coolant heater 365 that heats the coolant. Furthermore, coolant is caused to flow into the coolant cold plate 350 at a coolant inlet port 370 and out of the coolant cold plate 350 at a coolant outlet port 372.

These high voltage coolant heaters 365 generally operate together with a heat pump system, such as including the coolant pump 360 and leverage other heating cooling and air conditioning (HVAC) components. Such high voltage coolant heaters 365 and heat pump systems are large, heavy and expensive. The high voltage battery pack thermal management system 168 that leverages a low cost low voltage heating element 214 eliminates this expense while still providing necessary heating of the battery pack assembly 130 such as when the controller determines that current operating conditions (e.g., based on inputs 230) are below an ideal temperature threshold. In this way, the battery pack assembly 130 can be efficiently heated in cool operating conditions in a simple, low cost manner.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

It will be appreciated that the term “controller” or “control system” (as well as “module” and “unit”) as used herein refers to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

Unless specifically stated otherwise as apparent from the above discussion, it is appreciated that throughout the description, discussions utilizing terms such as “processing” or “computing” or “calculating” or “determining” or “displaying” or “commanding” or the like, refer to the action and processes of a computer system, or similar electronic computing device, that manipulates and transforms data represented as physical (electronic) quantities within the computer system memories or registers or other such information storage, transmission or display devices.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above. It will also be understood that the description, including disclosed examples and drawings, is merely exemplary in nature intended for purposes of illustration only and is not intended to limit the scope of the present disclosure, its application or uses. Thus, variations that do not depart from the gist of the present disclosure are intended to be within the scope of the present disclosure.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A thermal management system for an electrified vehicle, the thermal management system comprising:
a high voltage battery pack assembly comprising a battery module assembly that houses a plurality of battery cells within a high voltage battery case;
a low voltage battery;
a cooling system including a cold plate that is configured to cool the high voltage battery pack assembly; and
a low voltage heating system comprising a heating assembly having a heating element, the low voltage heating system powered by the low voltage battery and attached to the cold plate.

2. The thermal management system of claim 1, further comprising a low voltage heating system controller that commands the low voltage heating system to activate based on an input indicative of a temperature threshold being satisfied.

3. The thermal management system of claim 2, wherein the heating assembly includes a collection of heating grids.

4. The thermal management system of claim 2, wherein the heating assembly further comprises an adhesive that couples the low voltage heating system to the cold plate.

5. The thermal management system of claim 4, wherein the adhesive comprises thermal glue.

6. The thermal management system of claim 4, wherein the cooling system further comprises a chiller, a coolant fluid circuit and a coolant pump, wherein the coolant pump is configured to move coolant fluid through the coolant fluid circuit.

7. The thermal management system of claim 1, wherein the heating element is a resistive heating element.

8. The thermal management system of claim 6, wherein the cooling system is exclusive to cooling the cold plate without heating the coolant.

9. The thermal management system of claim 1, wherein the heating element is disposed within the high voltage battery case.

10. A method of operating a thermal management system for an electrified vehicle, the thermal management system comprising a high voltage battery pack assembly comprising a battery module assembly that houses a plurality of battery cells within a high voltage battery case, a low voltage battery, a cooling system including a cold plate that is configured to cool the high voltage battery pack assembly, and a low voltage heating system comprising a heating assembly having a heating element, the low voltage heating system powered by the low voltage battery and attached to the cold plate, the method comprising:
receiving, at a low voltage heating system controller, at least one input indicative of a temperature measurement;
determining, at the low voltage heating system controller, whether the at least one input satisfies a cold temperature threshold; and
activating the heating assembly based on the at least one input satisfying the cold temperature threshold.

11. The method of claim 10, wherein the heating assembly includes a collection of heating grids.

12. The method of claim 11, wherein the heating assembly further comprises an adhesive that couples the low voltage heating system to the cold plate.

13. The method of claim 12, wherein the adhesive comprises thermal glue.

14. The method of claim 13, wherein the cooling system further comprises a chiller, a coolant fluid circuit and a coolant pump, wherein the coolant pump is configured to move coolant fluid through the coolant fluid circuit.

15. The method of claim 10, wherein the heating element is a resistive heating element.

16. The method of claim 14, wherein the cooling system is exclusive to cooling the cold plate without heating the coolant.

17. The method of claim 10, wherein the heating element is disposed within the high voltage battery case.
